(19) United States
(12) Patent Application Publication
(10) Pub. No.: US 2014/0100841 A1
(43) Pub. Date: Apr. 10, 2014

(54) Testing a Hardware Emulation Model of a Circuit with Software Checker Routines Designed for an RTL Model of the Circuit

(71) Applicant: APPLE INC., Cupertino, CA (US)

(72) Inventors: Edmond R. Bures, Austin, TX (US); Jeffrey V. Lent, Austin, TX (US); Fritz A. Boehm, Dripping Springs, TX (US)

(73) Assignee: APPLE INC., Cupertino, CA (US)

(21) Appl. No.: 13/647,742

(22) Filed: Oct. 9, 2012

(51) Int. Cl. G06F 17/50

(52) U.S. Cl. 703/28

(57) ABSTRACT

A hardware emulation system may emulate a plurality of cycles of a circuit, and may store state information at each cycle which specifies signal values for one or more signals of the circuit. After the hardware emulation has finished, the state information may be streamed from the memory of the hardware emulation system to a different storage device that is accessible by a computer system that executes one or more software checker routines. The computer system may execute the software checker routines, which may include passing the signal values specified in the state information to the software checker routines on a cycle-by-cycle basis similarly as if the software checker routines were receiving them in real time directly from the hardware emulation system.

### BACKGROUND

1. Field of the Invention

This application is related to the field of circuit design verification, e.g., testing an electronic circuit design to determine whether it is operating correctly.

2. Description of the Related Art

Electronic circuits are composed of individual electronic components, such as transistors, resistors, capacitors, inductors and diodes, connected by conductive wires or traces through which electric current can flow. Due to the large number of these electronic components and the complexity of their interconnections, the design process for most circuits does not begin at the transistor level, but instead starts at a higher level of abstraction. For example, the circuit design process may begin by specifying an abstract diagram of the circuit architecture which illustrates the functional components of the circuit and how they operate together to perform the required functionality of the circuit. From this initial design, the circuit design may be gradually transformed into progressively lower level representations or models until finally the circuit designers arrive at the transistor level and have all the information needed to physically construct the circuit.

At each level of the circuit design process, it is possible for errors to be introduced into the design. If these errors remain undetected then they can end up in the physical circuit when it is manufactured. Thus, the circuit model produced at each level of the circuit design process may need to be tested to determine whether it is operating correctly.

One of the levels of abstraction used in the design process for many circuits is register-transfer level (RTL). Register-transfer level is a design abstraction that models the circuit in terms of the flow of digital signals (data) between hardware registers, and the logical operations performed on those signals. Hardware description languages (HDLs) such as Verilog and VHDL are used to model the circuit at the register-transfer level. Simulation software is often used at this level to verify the RTL model of the circuit. This is referred to as RTL simulation.

RTL simulation can be relatively easy, accurate, flexible, and low cost, but it is often not fast enough to allow large circuit designs to be tested, and the RTL level is still highly abstracted from the end goal of producing a transistor-level specification that can be used to build a physical implementation of the circuit.

Hardware emulation is another step used in the design process for many circuits. Hardware emulation is the process of imitating the behavior of the circuit under design with another piece of hardware, typically a special purpose emulation system that includes field-programmable gate arrays (FPGAs) or other programmable logic devices. The circuit may be emulated by compiling the HDL code of the RTL model into a netlist and then configuring the emulation system according to the netlist.

The emulation system may then physically emulate the circuit at a much faster rate of speed than can be achieved by the software-based RTL simulation. However, testing the hardware emulation model of the circuit to ensure that it is functioning correctly can be comparatively more difficult to achieve than testing the RTL model used in the software-based RTL simulation.

### SUMMARY

Various embodiments of a system and method for verifying or testing a circuit are described. The circuit design process may include emulating the circuit on a hardware emulation system and verifying or testing the circuit operation for functional correctness. More particularly, the hardware emulation may be tested by executing one or more software checker routines on a computer system. The software checker routines may receive information specifying values of circuit signals produced during the hardware emulation, and may use the signal values to analyze the behavior of the circuit, e.g., to determine whether the behavior is correct or as expected.

The hardware emulation system may emulate a plurality of cycles of the circuit. The hardware emulation system may be configured to store state information at each cycle which specifies the signal values for some of the circuit's signals, e.g., the signal values needed by the software checker routines. The state information indicating the signal values across the different cycles of the circuit emulation may be stored in memory of the hardware emulation system (e.g., in memory of the FPGA). After the hardware emulation has finished, the state information may be streamed from the memory of the hardware emulation system to a different storage device that is accessible by the computer system that executes the one or more software checker routines. The computer system may execute the software checker routines, which may include passing the signal values specified in the state information to the software checker routines on a cycle-by-cycle basis similarly as if the software checker routines were receiving them in real time directly from the hardware emulation system. Thus, the software checker routines may not need to execute concurrently with the hardware emulation system, but instead may use the stored state information that was generated at an earlier time during the operation of the hardware emulation system in order to analyze the circuit behavior on the hardware emulation system.

### BRIEF DESCRIPTION OF THE DRAWINGS

The following detailed description makes reference to the accompanying drawings, which are now briefly described.

FIG. 1 is a circuit diagram illustrating an example of a circuit;

FIG. 2 is a diagram illustrating that the same software checkers that are used to test an RTL model of the circuit may be re-used to test a hardware emulation of the circuit;

FIG. 3 illustrates one embodiment of a system for testing a circuit design;

FIG. 4 is a flowchart diagram illustrating one embodiment of a method for testing a circuit design;

FIGS. 5 and 6 illustrate alternative embodiments of the system;

FIG. 7 illustrates an example of a test bench computer system according to one embodiment; and

FIG. 8 is a block diagram illustrating a computer accessible storage medium that stores program instructions.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits and/or memory storing program instructions executable to implement the operation. The memory can include volatile memory such as static or dynamic random access memory and/or nonvolatile memory such as optical or magnetic disk storage, flash memory, programmable read-only memories, etc. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. §112, paragraph six interpretation for that unit/circuit/component.

### DETAILED DESCRIPTION OF EMBODIMENTS

Various embodiments of a system and method for performing circuit design verification are described. The circuit under design may be any kind of electronic circuit. For example, in some embodiments the circuit under design may be an integrated circuit (IC) or system-on-a-chip (SoC). In other embodiments the circuit may be a component or sub-circuit used in a chip or other larger circuit. The circuit may be intended for use in any type of system, device, or product. For example, in some embodiments the circuit may be used in a mobile phone or other handheld electronic device (e.g., after the design process has finished and after the physical circuit has been manufactured).

The circuit design process may include emulating the circuit on a hardware emulation system and verifying or testing the circuit operation for functional correctness. More particularly, the hardware emulation may be tested by executing one or more software checker routines on a test bench computer system. The software checker routines may execute to receive information specifying values of circuit signals (or values of nodes) produced during the hardware emulation and analyze the behavior of the circuit based on the signal values, e.g., to determine whether the behavior is correct or as expected.

As used herein, the term “hardware emulation system” may refer to any system that includes one or more programmable logic devices (PLDs). The term “programmable logic device” may refer to any device that can be configured with a netlist or other information describing the connectivity of an electronic design. As discussed below, in some embodiments the programmable logic device(s) of the hardware emulation system may include one or more FPGA devices. In other embodiments the hardware emulation system may includes other types of programmable logic devices. Examples of other types of programmable logic devices include programmable array logic (PAL) devices, generic array logic (GAL) devices, complex programmable logic devices (CPLDs), etc.

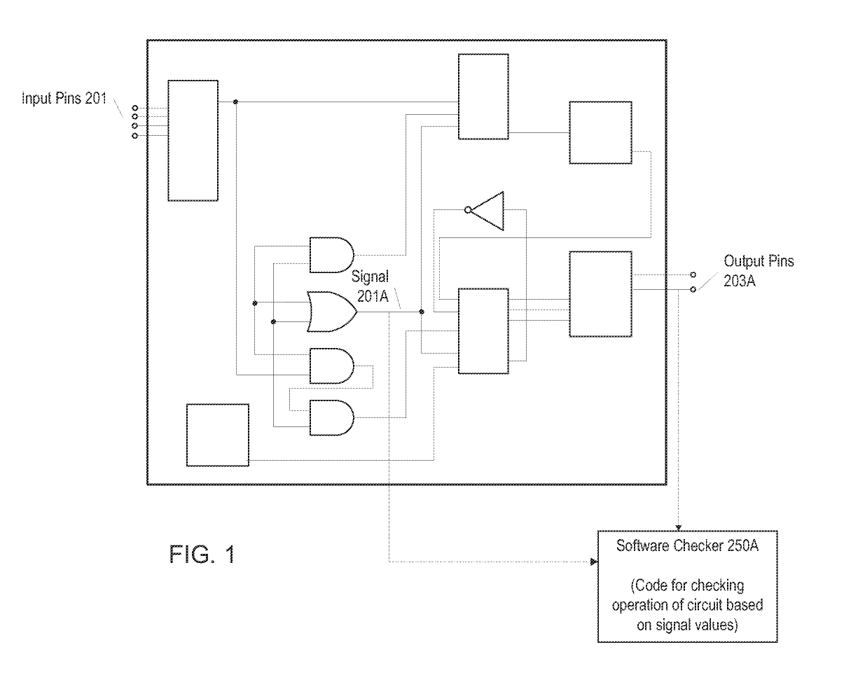

FIG. 1 illustrates an example of a circuit diagram for a digital circuit and a software checker routine 250A that receives input indicating a value of an internal signal 201A within the circuit and a value of an output pin 203A of the circuit. The hardware emulation system may be configured to emulate the circuit, e.g., by configuring one or more FPGAs or other programmable logic devices of the hardware emulation system with information (e.g., a netlist) produced from a model of the circuit. Thus, when the emulation system begins executing, the FPGA(s) may produce signals that represent the internal circuit signal 201A and the output signal on the output pin 203. Input indicating these signal values may be provided to the software checker routine 250A which executes on a separate test bench computer system. The software checker routine 250A may execute to analyze the behavior of the circuit based on the signal values. In various embodiments the design verification engineer may configure any number of software checker routines, each of which may execute to analyze the behavior of the circuit in any of various ways based on one or more of the circuit's signal values.

One possible way to implement the system would be to couple the execution of the software checker routines with the execution of the hardware emulation system such that the software checker routines are invoked on the test bench computer system in real time on a cycle-by-cycle basis to analyze the signal values produced by the hardware emulation system at each cycle. However, this may significantly slow down the hardware emulation since the hardware emulation system may be able to operate at a much faster rate (possibly orders of magnitude faster) than it takes the test bench computer system to execute the software checker routines.

Thus, in order to avoid slowing down the hardware emulation, the execution of the software checker routines may be de-coupled from the execution of the hardware emulation system. For example, the hardware emulation system may be configured to store state information at each cycle which specifies the signal values for some of the circuit's signals, e.g., the signal values needed by the software checker routines. The state information indicating the signal values across the different cycles of the circuit emulation may be stored in memory of the hardware emulation system (e.g., in memory of the FPGA). After the hardware emulation has finished, the state information may be streamed from the memory of the hardware emulation system to a separate test bench computer system which is configured to receive the state information and pass the signal values to the software checker routines on a cycle-by-cycle basis similarly as if the software checker routines were receiving them in real time directly from the hardware emulation system. Thus, the software checker routines may not need to execute concurrently with the hardware emulation system, but instead may use the stored state information that was generated at an earlier time during the operation of the hardware emulation system in order to analyze the circuit behavior on the hardware emulation system.

De-coupling the execution of the software checker routines on the test bench computer system from the execution of the hardware emulation system may enable the hardware emulation system to operate at full speed. This may be advantageous for circuit designers or organizations because hardware emulation systems can be very expensive, so it is often desirable to use them as efficiently as possible.

Another advantage that may be achieved by embodiments of the system and method is increased ease and flexibility in testing the hardware emulation phase of the circuit design process. In some conventional systems, the hardware emulation is tested by writing checkers in hardware description language (HDL) code. The HDL code that implements the checker functionality may then be synthesized, along with the other HDL code that implements the circuit model, into the netlist that is used to configure the emulation system. In this approach, the checker functionality effectively becomes part of the circuit model itself and is implemented directly on the emulation system. In contrast, the checker routines used in the present system and method may be software routines that do not execute directly on the emulation system, but instead execute on a separate test bench computer system. Moreover, the software checker routines may be written in a software programming language rather than a hardware description language. For example, in some embodiments the software checker routines may be written in C, C++, Java™, or another procedural programming language or object-oriented programming language. The use of a software programming language to write the checker routines rather than a hardware description language may make it much easier for the design verification engineer to implement the desired functionality for the checker routines, particularly for checker routines that perform analysis functions that are complex or that compute their results based on signal values generated across more than one cycle (which requires signal values to be stored across multiple cycles, and which can be difficult to implement with HDL code).

The software checker routines are also referred to herein as simply “software checkers.” In various embodiments the software checkers may include software functions, modules, or portions of code written in any software programming language or written using any software development platform. The software checkers may also execute on any type of computer system, and within any operating system or software environment.

In various embodiments the design verification engineer may write any number of software checkers. The software checker routines may be designed to perform any kind of analysis based on signal values or node values of the circuit, e.g., depending on the type of circuit and the desired test coverage. In some embodiments a software checker may compute a Boolean pass/fail result to indicate whether the circuit emulation passed a given test. Each software checker may be configured to receive any set of one or more of the signals of the circuit, again depending on what aspect of the circuit the software checker is designed to test. In some embodiments a software checker may track values of a given signal over time by storing information in memory indicating the value of the signal at different cycles of the circuit execution. The software checker may perform analysis and compute its result for a particular cycle based not only on the signal values at that particular cycle, but based also on signal values produced at previous cycles. This may enable the software checker to check complex behavior of the circuit based on the state of the circuit over time.

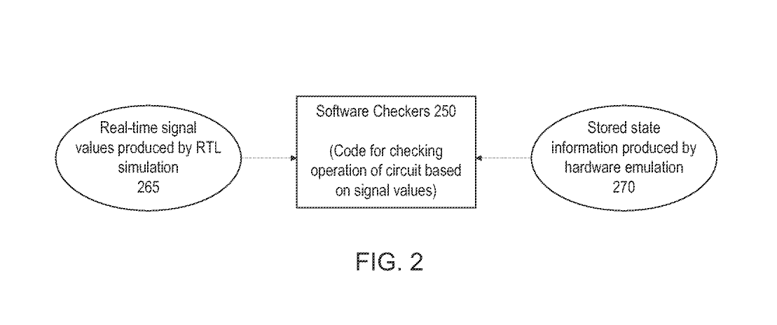

Another advantage that may be achieved by some embodiments of the system and method is increased efficiency in designing or writing the software checkers. In particular, in some embodiments, the same software checkers that are used to test the RTL model of the circuit in the RTL simulation phase of the design process may be re-used in the hardware emulation phase to test the operation of the hardware emulation, as shown in FIG. 2. This may enable the design verification engineer to write one set of software checkers that can be used for both of these phases of the circuit design process, thus avoiding the need to write or design separate checker functionality for each phase. During the RTL simulation phase, the software checkers 250 may execute concurrently with the execution of the RTL model in the simulation environment, e.g., so that the software checkers receive the simulated circuit signal values from the simulation environment in real time on a cycle-by-cycle basis. On the other hand, during the hardware emulation phase, the software checkers 250 may not need to execute concurrently with the hardware emulation system, but instead can receive the state information that was previously stored by the hardware emulation system, as described above.

In addition to re-using the RTL simulation software checkers to test the hardware emulation, the system and method may also enable new software checkers to be created. In some embodiments, in addition to or alternatively to streaming the state information stored during the hardware emulation from the memory of the hardware emulation system to the test bench computer system, the state information may also be copied into persistent storage, e.g., saved in one or more files or databases. As long as the state information remains available in storage, the state information can be analyzed at any time by any software checkers configured to operate based on the signal values that are stored within the state information. This may enable new software checkers to be written or existing software checkers to be changed even after the hardware emulation has been completed, which may further increase the test coverage range and flexibility.

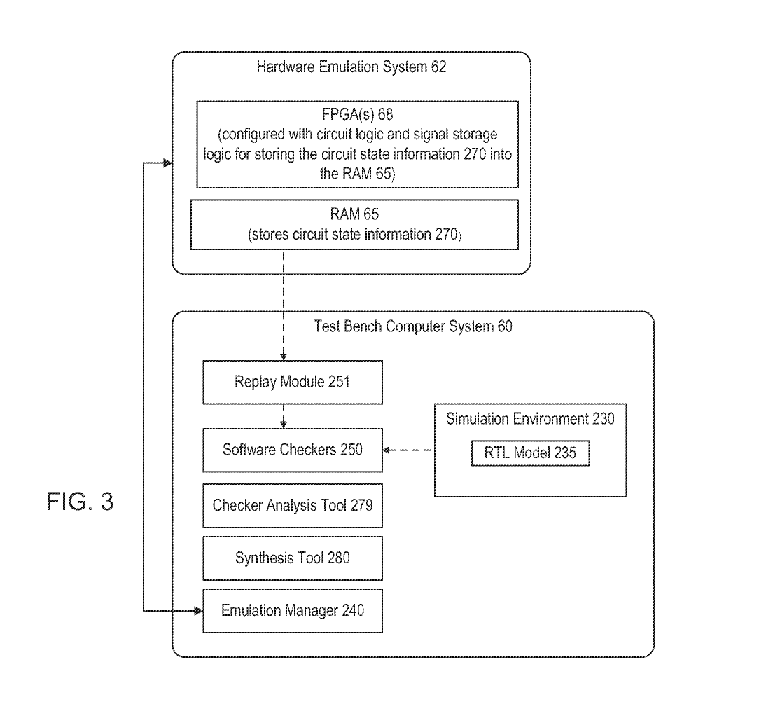

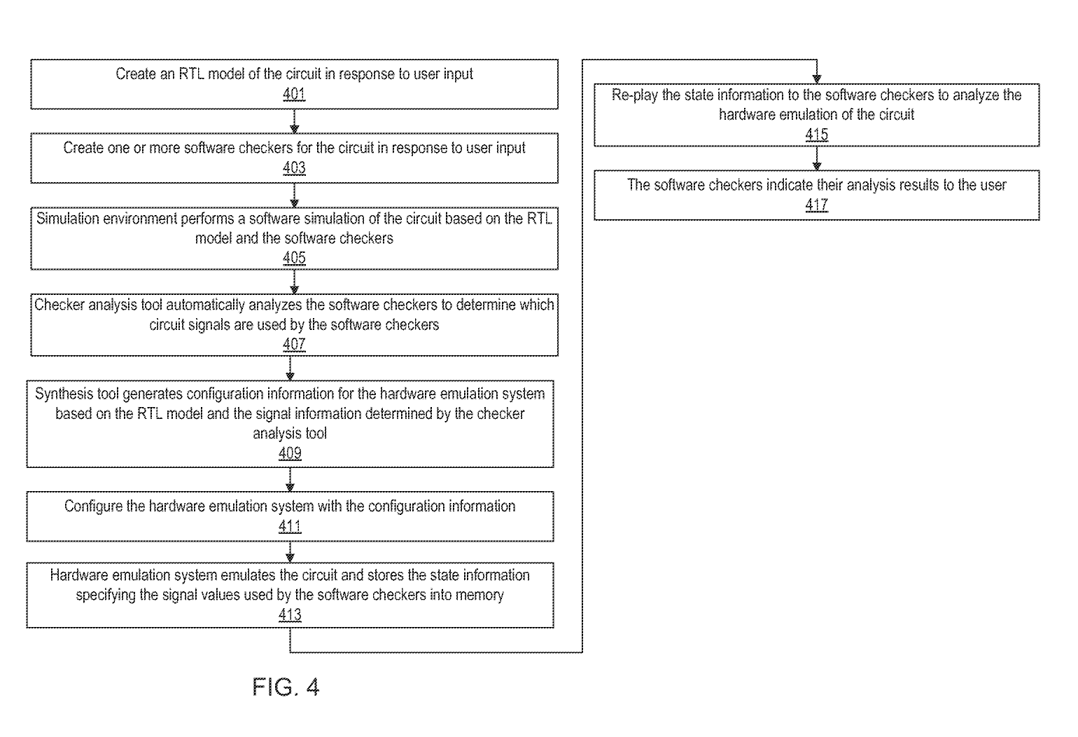

FIG. 3 illustrates various components of the system according to one embodiment. The system of FIG. 3 is described with reference to the flowchart of FIG. 4. In the illustrated embodiment, a test bench computer system 60 is configured to execute software implementing a simulation environment 230. For example, the user (e.g., design verification engineer) may create an RTL model 235 of the circuit by writing HDL code describing the behavior of the circuit. For example, the RTL model 235 may be created by a circuit design software tool provided by the simulation environment 230 in response to user input specifying the HDL code or other information that describes the circuit (block 401 of FIG. 4). The RTL model 235 may be stored in one or more files on a storage device accessible by the test bench computer system 60. (Since the HDL code describes the behavior of the circuit at the register-transfer level, the term “HDL code” is used interchangeably herein with the term “RTL code”.)

The user may also create one or more software checkers 250 designed to check the behavior of the circuit based on various signal values of the circuit. For example, the one or more software checkers 250 may be created by a programming development environment in response to user input specifying the software programming language code that implements the test or analysis functions to be performed by the software checker(s) 250 (block 403 of FIG. 4). The software checkers 250 may be stored in one or more files on a storage device accessible by the test bench computer system 60.

The simulation environment 230 may perform a software simulation of the circuit based on the RTL model 235, which may include the simulation environment 230 communicating with the software checkers 250 to pass various circuit signal values produced by the RTL simulation to the software checkers 250 so that they can analyze the RTL simulation (block 405 of FIG. 4). In various embodiments the software checkers 250 may interface with the simulation environment 230 in any of various ways in order to receive the signal values produced by the RTL simulation as input.

The user may perform multiple iterations of the RTL simulation phase. For example, if the software checkers 250 detect any errors in the simulated operation of the circuit, the user may modify the RTL model 235 until it behaves as expected.

Once the behavior of the RTL model is correct, the next phase of the circuit design process may be to perform a hardware emulation of the circuit. A synthesis software tool 280 may execute to transform the RTL model 235 of the circuit into a format that can be used to configure the hardware emulation system 62 to emulate the circuit. For example, the synthesis tool 280 may generate one or more bitstreams or other configuration information for programming one or more programmable logic devices of the hardware emulation system 62 to emulate the circuit. In some embodiments the programmable logic device(s) of the hardware emulation system 62 may include one or more FPGA devices 68.

As discussed above, in some embodiments the same software checkers 250 that are used to test the RTL simulation of the circuit may be re-used to test the hardware emulation of the circuit. In addition to being configuring with the logic to emulate the circuit, the FPGA(s) 68 of the hardware emulation system 62 may also be configured with additional logic to store the state information that specifies the circuit signal values needed by the software checkers 250. The additional logic, which is also referred to herein as signal storage logic, may operate to store the state information into random access memory (RAM) 65 of the hardware emulation system 62 during the emulation so that the stored state information can later be re-played to the software checkers 250 in order to test the hardware emulation. For example, for each circuit signal used by the software checkers 250, the signal storage logic may operate to store the respective value of the signal (e.g., “0” or “1”) in the RAM 65 at each respective cycle of the circuit.

The circuit signals that are needed for input to the software checkers 250 may only be a subset of all of the circuit's signals. Since the amount of RAM 65 may be limited, it may be desirable to store only the circuit signals that are needed by the software checkers 250 into the RAM 65. In some embodiments a checker analysis software tool 279 may execute to automatically analyze the software checkers 250 in order to determine which circuit signals are used by the software checkers 250, e.g., by performing a static analysis of the program code of the software checkers 250 (block 407 of FIG. 4). The checker analysis tool 279 may communicate with the synthesis tool 280 to inform the synthesis tool 280 which circuit signals are used by the software checkers 250.

In addition to generating the configuration information based on the RTL model 235 to program the hardware emulation system 62 to perform the circuit logic, the synthesis tool 280 may also generate additional configuration information based on the information received from the checker analysis tool 279 (block 409 of FIG. 4). The additional configuration information may be used to program the hardware emulation system 62 to perform the signal storage logic that stores the circuit signal values used by the software checkers 250 into the RAM 65. In some embodiments, the synthesis tool may generate the additional configuration information for programming the hardware emulation system 62 to perform the signal storage logic by first generating HDL code describing the signal storage logic, and then generating the additional configuration information based on the generated HDL code. In some embodiments the configuration information for programming the hardware emulation system 62 to perform the signal storage logic may be generated automatically, e.g., so that the hardware emulation system 62 can be automatically configured to perform the signal storage logic without requiring the user to implement the signal storage logic.

Once the hardware emulation system 62 has been configured (block 411 of FIG. 4), the emulation may be initiated. In some embodiments the test bench computer system 60 may execute emulation manager software 240 that communicates with the hardware emulation system 62 to control or manage the emulation. For example, the emulation manager 240 may be configured with test stimulus information that specifies input to be provided to the circuit via the circuit's input pins or I/O interface. The emulation manager 240 may communicate with the hardware emulation system 62 to provide the test stimulus input in order to drive the circuit through the desired sequence of operations. As the emulation proceeds, the state information 270 specifying the signal values needed by the software checkers 250 may be stored by the signal storage logic into the RAM 65 (block 413 of FIG. 4).

After the state information produced by the emulation has been stored into the RAM 65 of the hardware emulation system 62, the state information 270 may be transmitted from the RAM 65 to the test bench computer system 60 or to a storage device accessible by the test bench computer system 60. In various embodiments, any of various data transmission techniques may be used to transmit the state information 270 from the RAM 65 of the hardware emulation system 62 to the test bench computer system 60. For example, in some embodiments the test bench computer system 60 may be coupled to the hardware emulation system 62 via a HDDC cable or other direct connection that allows for high-speed data transfer, and the state information 270 may be streamed over the cable. In other embodiments the state information may be transmitted over an Ethernet connection or other type of network connection or communication port. Once received by the test bench computer system 60, the state information 270 may be stored in RAM of the test bench computer system 60 and/or may be persistently stored on a disk drive or other non-volatile storage device accessible by the test bench computer system 60, e.g., in one or more files or databases.

The state information 270 may then be “re-played” to the software checkers 250 (block 415 of FIG. 4) by a replay module 251 that executes on the test bench computer system 60 in conjunction with the software checkers 250. The replay module 251 may communicate with the software checkers 250 to pass the signal values specified in the state information 270 to the software checkers 250 on a cycle-by-cycle basis. At each respective cycle, the software checkers may thus receive as input the respective values for the respective signals used by the software checkers that were generated at that respective cycle when the hardware emulation was performed on the hardware emulation system 62. Based on the input provided by the replay module 251, the software checkers 250 may thus analyze the hardware emulation of the circuit. The software checkers may indicate the results of their analysis to the user, e.g., by displaying the analysis results in a graphical user interface on a display device of the test bench computer system 60 and/or by generating a report listing the analysis results (block 417 of FIG. 4).

As noted above, a software checker 250 may be designed to perform any kind of analysis or test based on one or more of the signal values of the circuit. Table 1 illustrates one example of a portion of C++ code that implements a software checker.

TABLE 1

bool simple_bus_checker::try_to_forget_tag(uint tag) {

deque<tag_t>::iterator itr = tag_deque.begin( );
while (itr != tag_deque.end()) {

if ((tag == itr−>tag)){

tag_deque.erase(itr);
return true;

}
itr++;

}
return false;

}
void simple_bus_checker::remember_tag(uint tag) {

tag_deque.push_back(tag);

}
void simple_bus_checker::check_bus( ) {

uint tag_in = get_val(“chip.tag_in[7:0]”);
uint tag_in_valid = get_val(“chip.tag_in_valid[0]”);
if (tag_in_valid) {

if (try_to_forget_tag(tag_in)) {

info(“everything is fine.”);

} else {

flag_error(“something is wrong!”);

}

uint tag_out = get_val(“chip.tag_out[7:0]”);
uint tag_out_valid = get_val(“chip.tag_out_valid[0]”);
if (tag_out_valid) {

remember tag(tag_out);

}

}

In the example of Table 1, the program code implements a software checker for a circuit that sends transactions over a bus. Each transaction sent over the bus is assigned a tag, and a response is expected for each transaction. The software checker keeps track of the tags and checks whether a tag that was assigned to a previous transaction gets re-used for a new transaction before a response to the previously sent transaction has been received. If so, this indicates an error.

In this example, the relevant signals of the circuit (chip) used by the software checker are acquired by the “get_val( )” function. Some of the signal values are stored in a queue so that the checker can keep track of the bus state over time. Queuing the signal values may be fairly easy to accomplish using C++ or another software programming language, but could be much more difficult and time-consuming to implement if the user had to design synthesizable RTL logic to implement the checker. The use of a software programming language to verify the circuit operation on the hardware emulation system may enable the user to easily design software checkers that analyze the circuit in arbitrarily complex ways, depending on the desired aspect of the circuit that needs to be verified.

As discussed above, the signal storage logic that stores the signal values used by the software checker into RAM may be integrated with the circuit logic. This may be done by generating RTL code defining the signal storage logic and then compiling it into the design together with the RTL model of the circuit. Table 2 is an example of RTL code that could be generated to define the signal storage logic for the software checker of Table 1.

TABLE 2
module simple_rtl_module;

| wire [31:0] store_signals_001; | |
|---|---|
| assign | store_signals_001 = |

{chip.tag_out[7:0],chip.tag_out_valid,chip.tag_in[7:0],chip.tag_in_valid};

| | |
|---|---|
| integer | store_signals_001_itr; |

initial

begin

store_signals_001_itr = 0;

end

reg store_signals_001_mem[0:\grave{ }sizeof_mem][31:0];
always @(posedge some_design_clk)

begin

store_signals_001 mem[store_signals_001_itr] = store_signals_001;
store_signals_001_itr = store_signals_001_itr + 1;

end

endmodule // simple_rtl_module

As noted above, in the program code of the software checker of FIG. 1, the “get_val( )” function is what acquires the circuit signal values used by the software checker. This function takes the name of the circuit signal as an input parameter and returns the value of the named signal. In order to enable the same software checker to be used for both the RTL simulation and the hardware emulation, the “get_val( )” function may be overloaded or may act as a wrapper so that it has different implementations depending on whether the software checker is currently analyzing the RTL simulation or the hardware emulation. For example, when analyzing the RTL simulation, the get_val( ) function may operate to interface with the simulation environment 230 to acquire the signal value from the simulation environment 230. When analyzing the hardware emulation, the get_val( ) function may operate to interface with the re-play module 251 to acquire the signal value from the stored state information 270.

In some embodiments the system may apply an optimization which enables a software checker to acquire multiple signal values with a single application programming interface (API) call (e.g., a single get_val( ) call). Since each signal value may be a represented as a single bit, multiple signal values may be packed into a single multi-bit integer, where each respective bit of the integer represents the value for a different respective signal. A single invocation of the get_val( ) function may thus return a 32-bit integer, for example, which represents the values for 32 different signals. The integer may then be unpacked to enable the software checker to reference the individual signals. In some embodiments the checker analysis tool and the synthesis tool 280 may operate together to implement this optimization, which in some embodiments may include automatically modifying the program code of the software checkers to implement the unpacking and eliminate duplicate API calls.

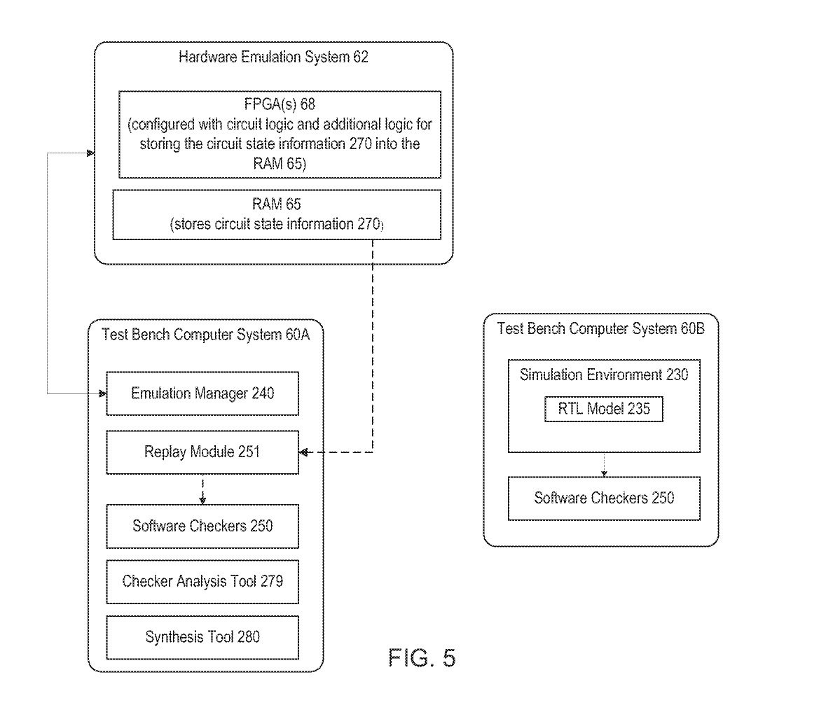

In various embodiments the system may take on any desired architecture other than the one shown in FIG. 3. For example, the various software components may be distributed across multiple test bench computer systems in various ways. FIG. 5 illustrates an example in which different test bench computer systems are used to analyze the RTL simulation and the hardware emulation. The test bench computer system 60B is configured to perform the RTL simulation, and a first instance of the software checkers 250 executes on the test bench computer system 60B to analyze the RTL simulation. Another test bench computer system 60A is configured to manage the hardware emulation, receive the state information 270 produced during the hardware emulation, and re-play it to a second instance of the software checkers 250 to analyze the hardware emulation.

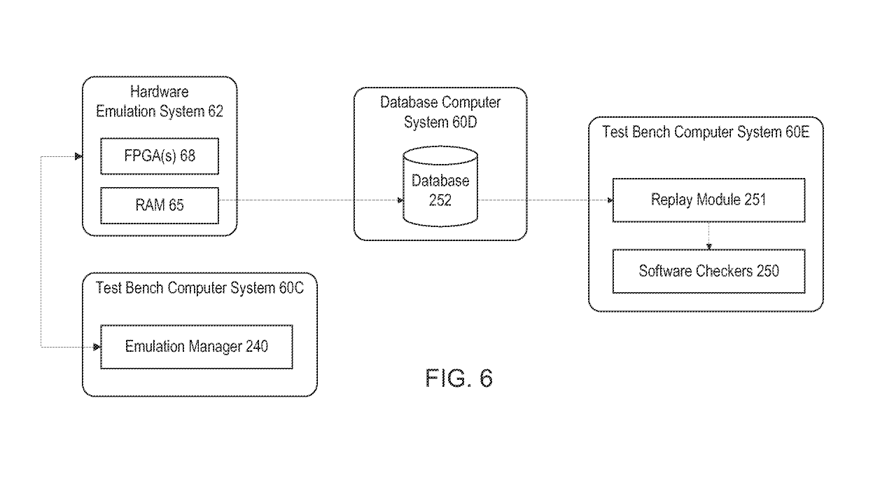

FIG. 6 illustrates another possible architecture of the system. In this example, the emulation manager executes on the test bench computer system 60C to manage the hardware emulation performed by the hardware emulation system 62. The state information 270 produced during the hardware emulation is transmitted to a database computer system 60D for persistent storage in a database 252. At a later time, the re-play module 251 can execute on another test bench computer system 60E to retrieve the state information 270 from the database and re-play it to the software checkers 250 so that they can analyze the results of the hardware emulation.

The test bench computer systems illustrated in FIGS. 3, 5, and 6 may each be or include any kind of computer system or device, such as a personal computer system (PC), workstation, network appliance, distributed computer system, tablet computer, handheld device, or other computing device or combinations of devices. In general, the term “computer system” can be broadly defined to encompass any device (or combination of devices) having at least one processor that executes instructions from one or more storage mediums.

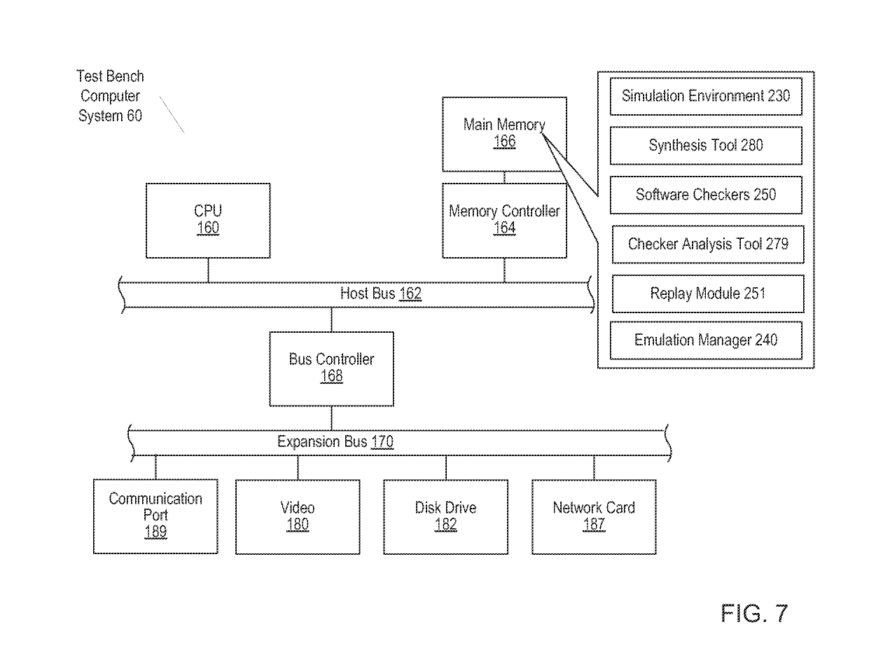

FIG. 7 illustrates an example of a test bench computer system 60 according to one embodiment. It is noted that in other embodiments the test bench computer system 60 may have any other configuration or architecture, and FIG. 7 illustrates a representative PC embodiment. Elements of a computer not necessary to understand the present description have been omitted for simplicity.

The test bench computer system 60 may include at least one processor or CPU 160 which is coupled to a processor or host bus 162. The CPU 160 may be any of various types. For example, in some embodiments, the processor 160 may be compatible with the x86 architecture, while in other embodiments the processor 160 may be compatible with the SPARC™ family of processors. Also, in some embodiments the test bench computer system 60 may include multiple processors 160.

The test bench computer system 60 may also include memory 166 in which program instructions implementing one or more of the software components discussed above are stored, such as one or more of the Simulation Environment 230, Synthesis Tool 280, Software Checkers 250, Checker Analysis Tool 279, Replay Module 251, and/or Emulation Manager 240. The memory 166 may also store operating system software 104 as well as other software used to control the operation of the test bench computer system 60.

In some embodiments the memory 166 may include one or more forms of random access memory (RAM) such as dynamic RAM (DRAM) or synchronous DRAM (SDRAM). In other embodiments, the memory 166 may include any other type of memory configured to store program instructions.

Referring again to FIG. 7, the host bus 162 may be coupled to an expansion or input/output bus 170 by means of a bus controller 168 or bus bridge logic. The expansion bus 170 may be the PCI (Peripheral Component Interconnect) expansion bus, although other bus types can be used. Various devices may be coupled to the expansion or input/output bus 170, such as a hard disk drive 182 which stores information in a non-volatile manner, as well as a video display subsystem 180 which sends video signals to a display device. In some embodiments the test bench computer system 60 may communicate with the hardware emulation system 62 through a communication port 189, network card 187, or other type communication device.

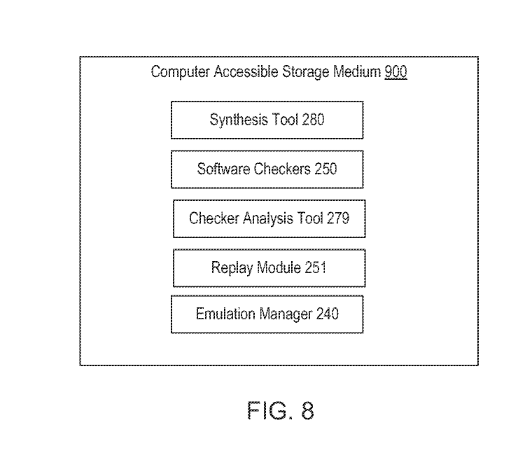

Turning now to FIG. 8, a block diagram of a computer accessible storage medium 900 is shown. The computer accessible storage medium 500 may store program instructions implementing one or more of the Synthesis Tool 280, Software Checkers 250, Checker Analysis Tool 279, Replay Module 251, and/or Emulation Manager 240. Generally, the computer accessible storage medium 900 may store any set of instructions which, when executed, implement a portion or all of the functions described herein.

Generally speaking, a computer accessible storage medium may include any storage media accessible by a computer during use to provide instructions and/or data to the computer. For example, a computer accessible storage medium may include storage media such as magnetic or optical media, e.g., disk (fixed or removable), tape, CD-ROM, DVD-ROM, CD-R, CD-RW, DVD-R, DVD-RW, or Blu-Ray. Storage media may further include volatile or non-volatile memory media such as RAM (e.g. synchronous dynamic RAM (SDRAM), Rambus DRAM (RDRAM), static RAM (SRAM), etc.), ROM, Flash memory, non-volatile memory (e.g. Flash memory) accessible via a peripheral interface such as the Universal Serial Bus (USB) interface, a flash memory interface (FMI), a serial peripheral interface (SPI), etc. Storage media may include microelectromechanical systems (MEMS), as well as storage media accessible via a communication medium such as a network and/or a wireless link. A carrier medium may include computer accessible storage media as well as transmission media such as wired or wireless transmission.

Numerous variations and modifications will become apparent to those skilled in the art once the above disclosure is fully appreciated. It is intended that the following claims be interpreted to embrace all such variations and modifications.

What is claimed is:

1. A method comprising:
emulating a circuit on one or more programmable logic devices, wherein said emulating produces state information indicating signal values of the circuit;
storing the state information; and
after the emulation has completed, executing one or more software checker routines on a computer system, wherein the one or more software checker routines receive the stored state information and analyze the emulation of the circuit.

2. The method of claim 1,
wherein said storing the state information comprises storing the state information in random access memory (RAM) of the one or more programmable logic devices.

3. The method of claim 2, wherein the method further comprises:
transferring the state information from the RAM of the one or more programmable logic devices to a storage device accessible by the computer system, wherein the one or more software checker routines receive the stored state information from the storage device.

4. The method of claim 1,
wherein said emulating the circuit comprises emulating a plurality of cycles of the circuit;
wherein said storing the state information comprises:
for each respective cycle of the plurality of cycles, storing a respective value of a first signal of the circuit at the respective cycle.

5. The method of claim 1, further comprising:
automatically analyzing the one or more software checker routines to determine one or more circuit signals used by the one or more software checker routines; and
automatically configuring the one or more programmable logic devices to store signal values for the one or more circuit signals used by the one or more software checker routines.

6. A system comprising:
a hardware emulation system; and
a computer system;
wherein the hardware emulation system is configured to store signal values of one or more signals of a circuit into memory of the hardware emulation system during an emulation of the circuit;
wherein the computer system is configured to receive the signal values of the one or more signals that were stored during the emulation of the circuit and pass the signal values as input to one or more software routines, wherein the one or more software routines are executable by the computer system to analyze the emulation of the circuit based on the signal values.

7. The system of claim 6,
wherein the computer system is coupled to the hardware emulation system via a cable;
wherein the hardware emulation system is configured to stream the signal values of the one or more signals that were stored during the emulation of the circuit to the computer system over the cable.

8. The system of claim 6,
wherein the one or more signals of the circuit includes a first signal, wherein the hardware emulation system is configured to emulate a plurality of cycles of the circuit and to store a respective value of the first signal into the memory of the hardware emulation system at each respective cycle of the plurality of cycles.

9. The system of claim 8,
wherein the one or more software routines includes a first software routine;
wherein for each respective value of the first signal that was stored into the memory of the hardware emulation system, the computer system is configured to:
receive the respective value of the first signal; and
perform a respective execution of the first software routine, wherein performing the respective execution includes passing the respective value of the first signal as input to the first software routine.

10. The system of claim 6,
wherein the hardware emulation system includes one or more programmable logic devices, wherein the one or more programmable logic devices are configured to emulate the circuit.

11. A system comprising:
a computer system; and
one or more programmable logic devices;
wherein the computer system is configured with a simulation environment for simulating a circuit and one or more software checker routines executable to receive signal values produced by the simulation in order to analyze the simulation;
wherein the computer system is further configured with first software executable to program the one or more programmable logic devices to perform a hardware emulation of the circuit, including programming the one or more programmable logic devices to store signal values produced by the emulation into memory of the one or more programmable logic devices;
wherein the computer system is further configured with second software executable to receive the signal values produced by the emulation and pass the signal values to the one or more software checker routines in order to analyze the hardware emulation.

12. The system of claim 11,
wherein the one or more programmable logic devices include one or more FPGA devices.

13. The system of claim 11,
wherein the one or more software checker routines are written in an object-oriented programming language.

14. The system of claim 11,
wherein the second software is executable by the computer system to receive the signal values produced by the emulation and pass the signal values to the one or more software checker routines after the hardware emulation has completed.

15. A computer-accessible storage medium storing program instructions executable by one or more processors to:
receive program code for implementing a software checker executable to analyze behavior of a circuit using one or more signals of the circuit;
automatically analyze the program code to determine the one or more signals of the circuit that are used by the software checker; and
generate configuration information for configuring a hardware emulation system to perform a hardware emulation of the circuit, wherein the configuration information includes first configuration information for configuring the hardware emulation system to perform circuit logic of the circuit and second configuration information for configuring the hardware emulation system to store values of the one or more signals of the circuit that are used by the software checker into memory of the hardware emulation system.

16. The computer-accessible storage medium of claim 15, wherein the program instructions are further executable by the one or more processors to:
automatically generate HDL code describing signal storage logic for storing the values of the one or more signals of the circuit into the memory, wherein the program instructions are executable by the one or more processors to generate the second configuration information from the automatically generated HDL code.

17. The computer-accessible storage medium of claim 15, wherein the program instructions are further executable by the one or more processors to:
after the hardware emulation system has performed a hardware emulation of the circuit, receive the values of the one or more signals of the circuit that were stored in the memory of the hardware emulation system.

18. The computer-accessible storage medium of claim 17, wherein the program instructions are further executable by the one or more processors to:
pass the values of the one or more signals of the circuit that were stored in the memory of the hardware emulation system as input to the software checker.

19. A method comprising:
performing a software simulation of a circuit on a computer system using a register-transfer level (RTL) model of the circuit, wherein performing the software simulation includes executing one or more software checker routines that receive circuit signal values produced by the software simulation and analyze the software simulation; and
re-using the one or more software checker routines to analyze a hardware emulation of the circuit performed by a hardware emulation system, wherein said re-using the one or more software checker routines comprises:
analyzing the one or more software checker routines to determine a plurality of signals of the circuit that are used by the one or more software checker routines;
generating RTL code based on the analysis of the one or more software checker routines, wherein the RTL code is configured to cause the hardware emulation system to store state information indicating values of the plurality of signals used by the one or more software checker routines memory;
configuring the hardware emulation system according to the RTL model of the circuit and the generated RTL code;
performing a hardware emulation of the circuit on the hardware emulation system, wherein performing the hardware emulation includes storing the state information indicating the values of the plurality of signals used by the one or more software checker routines into the memory; and
re-executing the one or more software checker routines, wherein the one or more software checker routines receive the state information and analyze the hardware emulation.

20. The method of claim 19,
wherein said re-executing the one or more software checker routines comprises re-executing the one or more software checker routines after the emulation of the circuit has completed.

21. The method of claim 19,
wherein said analyzing the one or more software checker routines comprises automatically analyzing program code of the one or more software checker routines to automatically determine the plurality of signals of the circuit that are used by the one or more software checker routines.

22. The method of claim 19,
wherein the one or more software checker routines are a first one or more software checker routines that exist before said performing the hardware emulation of the circuit;
wherein the method further comprises:
after the hardware emulation of the circuit has completed, receiving user input creating a new software checker routine for analyzing the hardware emulation; and
executing the new software checker routine, wherein executing the new software checker routine includes passing the state information produced during the hardware emulation of the circuit to the new software checker routine.
